(19) United States
(12) Patent Application Publication
(10) Pub. No.: US 2009/0091429 A1
(43) Pub. Date: Apr. 9, 2009

(54) COUPLER-INTEGRATED TRANSFORMER

(76) Inventors: No Gil Myoung, Daejeon (KR); Young Hyun Kim, Daejeon (KR); Byung Seok Park, Daejeon (KR); Hyo Yul Choi, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/237,349

(22) Filed: Sep. 24, 2008

(30) Foreign Application Priority Data
Sep. 28, 2007 (KR) 10-2007-0097790

(51) Int. Cl. G05B 11/01

(52) U.S. Cl. 340/310.11

(57) ABSTRACT

A coupler-integrated transformer for processing power line communication is disclosed. The transformer includes a sensor unit to obtain power and transformer state information, low- and high-voltage power line communication modules to send the power and transformer state information via a low-voltage or high-voltage power line, and to send a communication signal from the low-voltage power line to the high-voltage power line or vice versa via signal amplification, low- and high-voltage power line communication couplers connected to the low- and high-voltage power line communication modules to perform insertion and extraction of the communication signal with respect to a power distribution line, and a microcontroller to process the information from the sensor unit and supply the processed information to the power line communication modules. The transformer enables easy set-up of a communication network system with customers adjacent to the transformer using high-voltage power line communication, achieving a remarkable increase in system capacity.

### BACKGROUND OF THE INVENTION

1. Field of the Invention

The present invention relates to coupler-integrated transformers, and more particularly to coupler-integrated transformers for processing power line communication.

2. Description of the Related Art

Power line communication (PLC) techniques enable communication through power lines used for supplying electric power, and are widely used in practice due to various merits of easy setup, convenient use, inexpensive installation, and the like.

Particularly, a communication network for constructing a management and monitoring system of power equipment to achieve stable power supply is employed as a communication network for supplying value-added service and remote monitoring of customers (which generally refer to a home, industries, buildings, and the like as end users of electricity supplied from a power company).

However, since a power line communication signal having features of high frequency band cannot pass through a transformer, power line communication is performed differently for high-voltage power line communication and low-voltage power line communication.

In this regard, for the low-voltage power line communication wherein communication lines are constructed with customers at the downstream side of the transformer, communication capacity is limited to a single transformer-installed electric pole, causing low economic efficiency despite its technical merits. To solve this problem, a conventional technique attempts to interlock with high-voltage power line communication used for monitoring electronic devices as shown in FIG. 1, but for this purpose, it is necessary to install a separate high-voltage coupler 2 on a high-voltage network on a transformer-installed electric pole 1.

However, the installation of the high-voltage coupler 2 on the high-voltage network entails installation difficulty, lack of installation space, high cost in installation and construction, so that it fails to provide fundamental solutions of the problems of the prior art.

### SUMMARY OF THE INVENTION

The present invention is conceived to solve the problems of the conventional techniques as described above, and an aspect of the present invention is to provide a transformer that includes a coupler for processing a power line communication signal.

In accordance with an aspect of the present invention, there is provided a coupler-integrated transformer for interlocking between high-voltage and low-voltage power line communications. The coupler-integrated transformer includes: a sensor unit comprising a power sensor to obtain power state information needed in managing power quality and load, and a transformer monitoring sensor to obtain transformer state information; low-voltage and high-voltage power line communication modules to send the power state information and the transformer state information in a remote transmission manner using a low-voltage power line or a high-voltage power line, and to send a communication signal from the low-voltage power line to the high-voltage power line or vice versa via signal amplification; low-voltage and high-voltage power line communication couplers respectively connected to the low-voltage and high-voltage power line communication modules to perform insertion and extraction of the communication signal with respect to a power distribution line; and a microcontroller coupled to the sensor unit and the low-voltage and high-voltage power line communication modules to process the information obtained from the sensor unit and to supply the processed information to the low-voltage and high-voltage power line communication modules.

The power sensor may include a current sensor or a voltage sensor, and the transformer monitoring sensor may include a temperature sensor or an oil sensor.

When the power state information, the transformer state information, and the power line communication signal are used over an alternative communication network, an external communication interface such as USB, RS232, UART, Ethernet and the like may be used.

The coupler-integrated transformer may further include: an analog/digital converter connected to the sensor unit via an interface to receive an analog signal from the sensor unit and to convert the received analog signal into a digital signal; a digital signal processor to process and analyze the digital signal converted by the analog/digital converter; and a memory to store information processed by the digital processing unit.

The microcontroller may manage the information processed by the digital processing unit.

The low-voltage coupler and the low-voltage power line communication module may be provided outside the transformer.

Unlike the conventional transformer which is separately operated in different manners with respect to low-voltage power line communication and high-voltage power line communication due to technical problems thereof, the transformer of the present invention enables low-voltage power line communication and high-voltage power line communication to be performed in a single system by integrating a coupler, thereby achieving increased hardware integrity, size reduction, high efficiency management and installation, and cost reduction.

Further, the transformer of the present invention enables easy interlocking between high-voltage and low-voltage so that a communication network system with customers adjacent to the transformer can be easily established using high-voltage power line communication, thereby achieving a remarkable increase in system capacity.

Moreover, based on the merit of easy establishment of the communication network, the transformer of the present invention enables transmission of state information of transformers, which are distributed throughout a country, to a management system using a power line communication technique, thereby maximizing the utilization value of power lines.

### BRIEF DESCRIPTION OF THE DRAWINGS

The above and other objects, features and advantages of the present invention will become apparent from the following description of exemplary embodiments given in conjunction with the accompanying drawings, in which:

FIG. 1 is an exemplary diagram of a conventional power line communication system established using a high-voltage power line and a low-voltage power line;

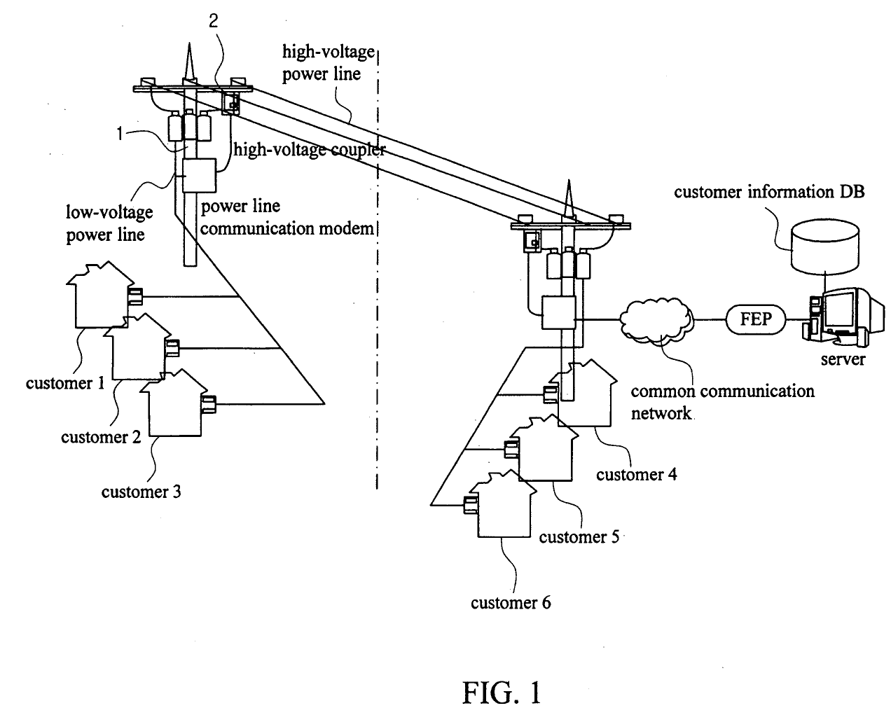

FIG. 2 is a schematic block diagram of a coupler-integrated transformer according to one embodiment of the present invention;

FIG. 3 is a block diagram illustrating a configuration and information flow of a coupler-integrated digital transformer for power line communication according to one embodiment of the present invention; and

FIG. 4 is a view of a remote measurement system operated by interlocking between a high-voltage power line and a low-voltage power line according to one embodiment of the present invention.

### DETAILED DESCRIPTION OF THE INVENTION

Exemplary embodiments of the present invention are described in detail with reference to the accompanying drawings hereinafter. In description of the present invention, a detailed description of well-known functions or components will be omitted herein for clarity.

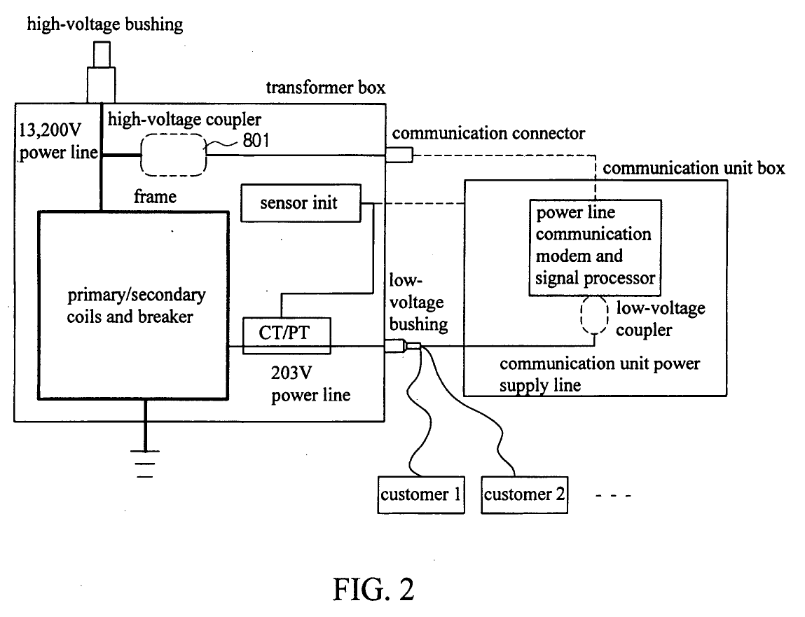

FIG. 2 is a schematic block diagram of a coupler-integrated transformer according to one embodiment of the present invention.

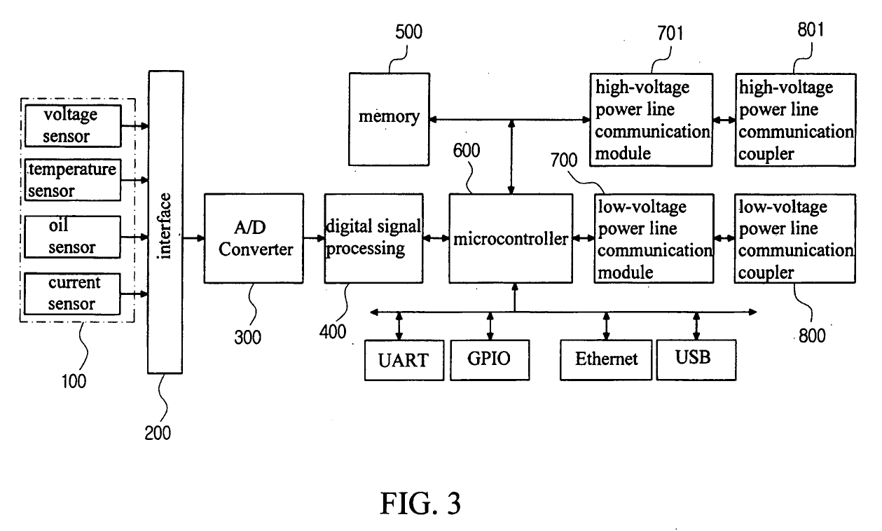

In FIG. 2, the transformer includes a sensor unit for obtaining information of a transformer state, a microcontroller (see FIG. 3) for processing the obtained information, a coupler, and power line communication module for transmitting information via power line communication. Meanwhile, although FIG. 2 shows a communication system box as being attached to the outside of a transformer box in this embodiment, the communication system box may also be disposed inside the transformer box.

The sensor unit is connected not only to a current transformer/potential transformer (CT/PT), but also to a power line communication modem disposed inside the communication system box, which is disposed outside the transformer in this embodiment.

FIG. 3 is a block diagram illustrating a configuration and information flow of a coupler-integrated digital transformer for power line communication according to one embodiment of the present invention.

In FIG. 3, the coupler-integrated digital transformer for power line communication according to this embodiment includes a sensor unit 100. The sensor unit 100 includes a power state sensor (for example, an electrical power sensor including a current sensor, a voltage sensor, or the like) that serves to obtain power state information, which will be used for management of power quality and load such as voltage, current, frequency, power factor, and the like, and a transformer state sensor (for example, a transformer monitoring sensor including a temperature sensor, an oil sensor or the like) that serves to obtain transformer state information such as temperature, oil, and the like.

Further, the transformer includes an analog/digital converter (A/D converter) 300 that receives an analogue signal from the sensor unit 100 via an interface 200 connected to the sensor unit 100, and that converts the analog signal to a digital signal.

Further, the transformer includes a digital signal processor 400 that is connected to the sensor unit 100 via the interface 200 to process and analyze the digital signal, which has been converted by the analog/digital converter 300.

A variety of information processed by the digital signal processor 400 is stored in a memory 500.

The transformer further includes a microcontroller 600 connected to the digital signal processor 400 to process and analyze the digital signal.

Additionally, the transformer includes power line communication modules 700 and 701 used for communication of the analyzed information via a power distribution line.

Moreover, the transformer includes power line communication couplers 800 and 801 that insert and extract a communication signal into or from the power distribution line.

Next, configuration and operation of the coupler-integrated transformer according to the embodiment of the invention will be described in more detail.

As shown in FIG. 3, the sensor unit 100 includes the electric current sensor, the voltage sensor, the temperature sensor, the oil sensor, and the like. The current sensor and the voltage sensor are used to detect electric current and voltage, respectively.

Further, the temperature sensor of the sensor unit 100 measures an inner temperature of the transformer. If the transformer is an oil transformer, the oil sensor detects the characteristics of a transformer-oil inside the transformer to indicate a reduction in performance of the transformer oil or shortage of the transformer-oil.

As described above, analog signals obtained by the current sensor, the voltage sensor, the temperature sensor or the oil sensor constituting the sensor unit 100 are converted to digital signals via the A/D converter 300 that is connected to these sensors through the interface 200.

The digital signals converted by the A/D converter 300 are then subjected to operation of the digital signal processor 400 to be converted to useful information for a manger.

Further, the microcontroller 600 connected to the digital signal processor 400 manages the useful information converted through the digital signal processor 400, and is connected to an external communication interface such as UART, GPIO, Ethernet, USB or the like to process information relating thereto.

When the power state information, the transformer state information, and the power line communication signal obtained through the high-voltage power line (or low-voltage power line) are used over an alternative communication network, the external communication interface such as USB, RS232, UART, Ethernet or the like is used.

The memory 500 connected to the microcontroller 600 stores the information converted by the digital signal processor 400 together with information such as a date of manufacture, an installation date, and the like of the associated transformer such that management of the transformer can be efficiently carried out by transmitting the information to a management server 900 through an existing backbone network via the power line communication module 701.

The power line communication module serves to convert the information processed by the microcontroller 600 or the information stored in the memory to information suitable for communication, or to convert communication signals received through the power line to digital signals.

Further, the power line communication module serves to reproduce the power line communication signals received from the low-voltage power line (or the high-voltage power line) and to relay the reproduced power line communication signals as high voltage (or low voltage) power line communication signals. As such, the communication signals converted through the power line communication module are applied to the power line in the form of analog signals through the coupler.

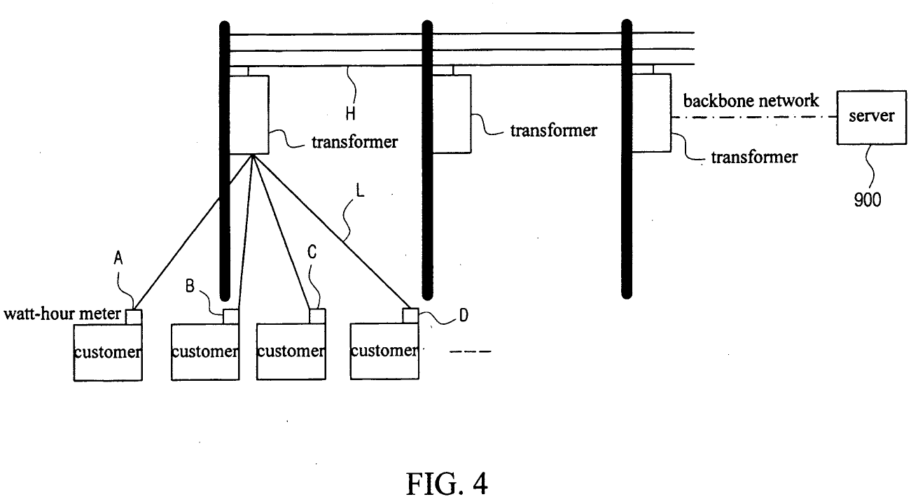

FIG. 4 is a schematic view of an exemplary system established using the power line communication coupler-integrated transformer according to the embodiment of the invention.

Referring to FIG. 4, remote measurement information obtained through each of low-voltage watt-hour meters (A, B, C, D, . . . ) is first sent to the transformer constructed as described above through a low-voltage power line L, processed together with transformation state information by the microcontroller in the transformer, and is then sent to a high-voltage power line H through the coupler disposed inside the transformer.

After being extracted from a plurality of transformers as described above, the information (remote measurement and transformer information) is collected in a certain transformer through a high-voltage network and is then sent to a server 900 through an existing backbone network.

As such, the transformer of the present invention can remarkably improve the capacity of a low-voltage power line communication system and permits easy interlink between a low-voltage network and a high-voltage network. Further, the information of the transformer can be managed and monitored through establishment of a communication network.

As apparent from the above description, the transformer of the present invention can provide easy interlocking between low-voltage power line communication and high-voltage power line communication by solving the problem of power line communication that a communication signal cannot pass through a conventional transformer.

In other words, as is different from the conventional transformer which is separately operated in different manners with respect to low-voltage power line communication and high-voltage power line communication, the transformer according to the present invention incorporates a coupler capable of allowing a power line communication signal to pass through the transformer to allow easy interlocking between low-voltage power line communication and high-voltage power line communication, thereby improving the capacity of the low-voltage power line communication system while supplying inexpensive communication services to consumers.

For example, although it is necessary for each transformer-installed electric pole to have a backbone network in construction of a remote measurement system in the prior art, the present invention enables remote measurement information collected by the respective transformer-installed electric poles to be collected in a single transformer through a high-voltage line, so that an innovative result in view of usage and operation costs of a communication network can be expected.

Moreover, based on the merit of easy setup of the communication network, the transformer of the present invention enables transmission of state information of transformers, which are distributed throughout a country, to a management system using a power line communication technique, thereby maximizing the utilization value of power lines.

Although the present invention has been described with reference to the embodiments and the accompanying drawings, the invention is not limited to the embodiments and the drawings. It should be understood that various modifications and variation can be made by those skilled in the art without departing from the spirit and scope of the present invention defined by the accompanying claims.

What is claimed is:

1. A coupler-integrated transformer for interlocking between high-voltage and low-voltage power line communications, comprising:
a sensor unit comprising a power sensor to obtain power state information needed in managing power quality and load, and a transformer monitoring sensor to obtain transformer state information;
low-voltage and high-voltage power line communication modules to send the power state information and the transformer state information in a remote transmission manner using a low-voltage power line or a high-voltage power line, and to send a communication signal from the low-voltage power line to the high-voltage power line or vice versa via signal amplification;
low-voltage and high-voltage power line communication couplers respectively connected to the low-voltage and high-voltage power line communication modules to perform insertion and extraction of the communication signal with respect to a power distribution line; and
a microcontroller coupled to the sensor unit and the low-voltage and high-voltage power line communication modules to process the information obtained from the sensor unit and to supply the processed information to the low-voltage and high-voltage power line communication modules.

2. The coupler-integrated transformer according to claim 1, wherein the power sensor comprises a current sensor or a voltage sensor, and the transformer monitoring sensor comprises a temperature sensor or an oil sensor.

3. The coupler-integrated transformer according to claim 1, wherein when the power state information, the transformer state information, and the power line communication signal are used over an alternative communication network, an external communication interface selected from USB, RS232, UART, and Ethernet is used

4. The coupler-integrated transformer according to claim 1, further comprising:
an analog/digital converter connected to the sensor unit via an interface to receive an analog signal from the sensor unit and to convert the received analog signal into a digital signal;
a digital signal processor to process and analyze the digital signal converted by the analog/digital converter; and
a memory to store information processed by the digital processing unit,
wherein the microcontroller manages the information processed by the digital processing unit

5. The coupler-integrated transformer according to claim 1, wherein the low-voltage coupler and the low-voltage power line communication module are provided outside the transformer.
